(19) United States
(12) Patent Application Publication
(10) Pub. No.: US 2017/0248068 A1
(43) Pub. Date: Aug. 31, 2017

(54) BYPASS VALVE FOR COMPRESSOR

(71) Applicant: BorgWarner Inc., Auburn Hills, MI (US)

(72) Inventor: John SHUTTY, Clarkston, MI (US)

(21) Appl. No.: 15/516,440

(22) PCT Filed: Sep. 22, 2015
(86) PCT No.: PCT/US2015/051334

§ 371 Date: Apr. 3, 2017

Related U.S. Application Data
(60) Provisional application No. 62/060,728, filed on Oct. 7, 2014.

(51) Int. Cl. F02B 37/04; F04D 27/02; F04D 25/16; F02D 41/00; F02B 31/06

(52) U.S. Cl. CPC F02B 37/04; F02D 41/0007; F02B 31/06; F04D 25/16; F04D 27/0246; F04D 27/0269; F02D 2041/0015

(57) ABSTRACT

A product and method are disclosed for use with an engine including an intake passage providing combustion air to the engine. An exhaust passage may channel expelled combustion gases from the engine. A first compressor may be disposed in the intake passage, and a turbine may be disposed in the exhaust passage and may be coupled to the first compressor. The turbine may be arranged to rotate as a result of a flow of exhaust gases through the exhaust passage to drive the first compressor. A flow control device may be disposed in the intake passage upstream from the first compressor. An alternate passage may be provided having a first end opening to the intake passage upstream from the flow control device and having a second end opening to the intake passage downstream from the flow control device. A second compressor may be disposed in the alternate passage, with a drive unit adapted to drive the second compressor. The flow control device may be adapted to be closed to substantially prevent flow through the intake passage and to be open to impart swirl to a gas stream in the intake passage.

### CROSS-REFERENCE TO RELATED APPLICATIONS

This application claims the benefit of U.S. Provisional Application No. 62/060,728 filed Oct. 7, 2014.

### TECHNICAL FIELD

The field to which the disclosure generally relates includes charging systems for internal combustion engines and more particularly to charging systems that include multiple boosting devices.

### BACKGROUND

Internal combustion engines for automotive applications may include charging systems with boosting devices such as turbochargers or superchargers. A desire for high boost pressure even at low engine output may drive the use of two or more charging units for different operating conditions of one engine.

### SUMMARY OF ILLUSTRATIVE VARIATIONS

According to a number of variations a method of controlling a compressor bypass in a charging system for an internal combustion engine may be provided. The method may include providing a first compressor and connecting the first compressor in an intake passage of the internal combustion engine. Providing a second compressor and connecting the second compressor in the intake passage of the internal combustion engine may also be included. A bypass passage may be included in the intake passage around the second compressor so that gas can flow through the bypass passage without being forced to go through the second compressor. A flow control device having a number of vanes may be connected in the bypass passage. The vanes in the flow control device may be selectively positioned to a closed position to force flow through the second compressor.

A number of other variations may include a product for use with an engine including an intake passage providing combustion air to the engine. An exhaust passage may channel expelled combustion gases from the engine. A first compressor may be disposed in the intake passage, and a turbine may be disposed in the exhaust passage and may be coupled to the first compressor. The turbine may be configured to rotate as a result of a flow of exhaust gases through the exhaust passage to drive the first compressor. A flow control device may be disposed in the intake passage upstream from the first compressor. An alternate passage may be provided having a first end opening to the intake passage upstream from the flow control device and having a second end opening to the intake passage downstream from the flow control device. A second compressor may be disposed in the alternate passage, with a drive unit adapted to drive the second compressor. The flow control device may be adapted to be closed to substantially prevent flow through the flow control device and force flow through the alternate passage.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a dual charging system arrangement according to a number of variations.

FIG. 2 is a schematic view across an intake passage showing a flow control device according to a number of variations.

FIG. 3 is a schematic view across an intake passage showing a flow control device according to a number of variations.

### DETAILED DESCRIPTION OF ILLUSTRATIVE VARIATIONS

The following description of the variations is merely illustrative in nature and is in no way intended to limit the scope of the invention, its application, or uses.

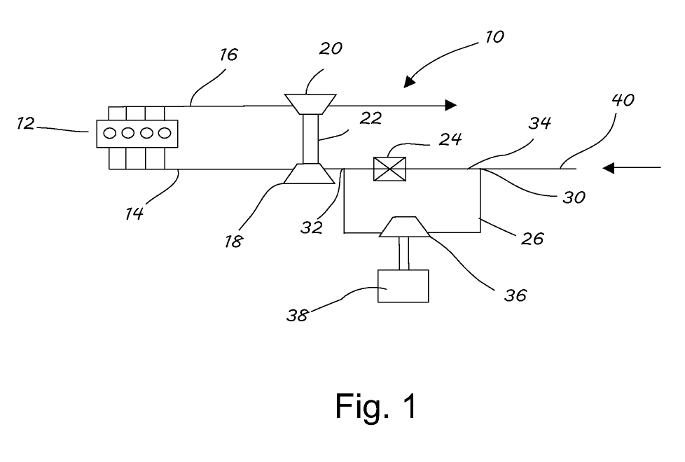

A charging system for an internal combustion engine may include at least one device for compressing combustion air entering the engine. Referring to FIG. 1, a charging system 10 according to a number of variations is illustrated. Charging system 10 may include an engine 12 including an intake passage 14, providing combustion air to one or more of the cylinders of the engine 12. An exhaust passage 16 may channel expelled combustion gases from the cylinders of engine 12. A first compressor 18 may be disposed in the intake passage 14, and may be connected to a turbine 20 through a shaft 22. Turbine 20 may be disposed in the exhaust passage 16 so that expelled exhaust gases rotate the turbine which drives connected compressor 18.

A flow control device 24 may be disposed in the intake passage 14 upstream from the first compressor 18. Flow control devices to impart swirl or whirl to spin a gas stream in the intake passage are known. One such device is described in U.S. Pat. No. 6,994,518 for a Pre-Whirl Generator for Radial Compressor, which is assigned to the assignee of this invention. U.S. Pat. No. 6,994,518 is specifically incorporated herein by reference. The benefits of imparting swirl may include improving the efficiency of compressor 18, increasing the mixing of recirculated exhaust gas, and improving combustion in the engine 12.

An alternate passage 26 may be provided for the flow of intake gases in intake passage 14. A first end 30 may open the alternate passage 26 to the intake passage 14 upstream from the flow control device 24. A second end 32 may open the alternate passage 26 to the intake passage 14 downstream from the flow control device 24. As a result, intake flow may proceed from the end 30 to the end 32 through either or both of the passage segment 34 of intake passage 14 and the alternate passage 26. A second compressor 36 may be disposed in the alternate passage 26, with a drive unit 38 adapted to drive the second compressor 36. Drive unit 38 may include a device to impart rotation such as an electric drive motor, an engine power take off, a turbine, or another drive system. Flow control device 24 may allow flow through the segment 34 bypassing the alternate passage 26 and the second compressor 36.

The flow control device 24 is adapted to be closed to substantially prevent flow through the segment 34 of intake passage 14 and to be open to impart swirl to the gas stream. Intake gases entering the charging system 10 at intake passage segment 40 may flow through segment 34 and flow control device 24 to first compressor 18 when flow control device 24 is open. Intake gases entering the charging system 10 at intake passage segment 40 may also flow through alternate passage 26, second compressor 36 and through end 32 to first compressor 18, when flow control device 24 is open, partially open or closed. Drive unit 38 may be driven to rotate compressor 36 charging the gas stream in intake passage 14 to engine 12 when flow control device 24 is open, partially open or closed. For example, when engine 12 is initially started or operating under low load and exhaust gas flow in exhaust passage 16 is low, flow control device 24 may be closed and drive unit 38 may be driven to rotate second compressor 36 and charge the intake passage 14. Since flow control device 24 is closed, back flow through it and segment 34 is prevented directing the charged gas flow to engine 12. In addition, when flow control device 24 is open and turbine 20 is driving first compressor 18 to charge intake passage 14, drive unit 38 may drive compressor 36 to assist in charging intake passage 14. In the case of a supercharger as the second compressor 36, flow through the alternate passage 26 may be blocked when not driven by the drive unit 38. With an electric driven booster as the second compressor 36, gas flow may spin the compressor and some gas flow through the alternate passage 26 may be possible. The flow control device 24 may be positioned to allow flow freely through the segment 34 without being forced through the second compressor. Closing the flow control device 34 may prevent backflow from the second compressor to its inlet.

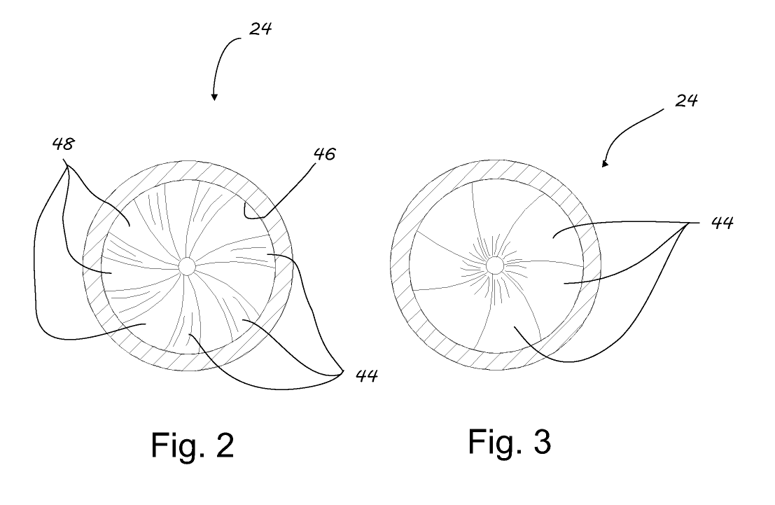

Referring to FIG. 2, a schematic illustration of flow control device 24 shows a number of vanes 44 disposed in the flow passage 46 through the flow control device, which may be rotated between an open position shown in FIG. 2 and a closed position shown in FIG. 3. The number and shape of vanes 44 may be selected to close the flow passage 46 when rotated to an orientation perpendicular to the flow passage 46 as shown in FIG. 3. When the vanes are rotated to an open position as shown in FIG. 2 with openings 48, they may be oriented to impart swirl to the flow stream. In this manner flow may be prevented or selectively influenced through the flow control device 24 without requiring a separate shut off valve in the intake passage 14 to prevent flow through segment 34.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include a method for controlling a compressor bypass in a charging system for an internal combustion engine. The method may include providing a first compressor and connecting the first compressor in an intake passage of the internal combustion engine. Providing a second compressor and connecting the second compressor in the intake passage of the internal combustion engine may also be included. A bypass passage may be included in the intake passage around the second compressor so that gas can flow through the bypass passage without being forced through the second compressor. A flow control device having a number of vanes may be connected in the bypass passage. The vanes in the flow control device may be selectively positioned to a closed position to force flow through the second compressor.

Variation 2 may include a method according to variation 1 including the step of opening the vanes to impart swirl in the intake passage and into the first compressor.

Variation 3 may include a method according to variation 1 or 2 including the step of operating the first and second compressors concurrently.

Variation 4 may include a method according to Variation 2 including the step of operating the second compressor when the engine is initially started and the vanes are positioned in the closed position.

Variation 5 may include a product for use with an engine including an intake passage providing combustion air to the engine. An exhaust passage may channel expelled combustion gases from the engine. A first compressor may be disposed in the intake passage, and a turbine may be disposed in the exhaust passage and may be coupled to the first compressor. The turbine may be arranged to rotate as a result of a flow of exhaust gases through the exhaust passage to drive the first compressor. A flow control device may be disposed in the intake passage upstream from the first compressor. An alternate passage may be provided having a first end opening to the intake passage upstream from the flow control device and having a second end opening to the intake passage downstream from the flow control device. A second compressor may be disposed in the alternate passage, with a drive unit adapted to drive the second compressor. The flow control device may be adapted to be closed to substantially prevent flow through the flow control device and force flow through the alternate passage.

Variation 6 may include a product according to variation 5 wherein the flow control device includes a number of vanes that are shaped to substantially close flow through the flow control device when positioned perpendicular to flow.

Variation 7 may include a product according to variation 6 wherein the vanes are configured to close flow and the second compressor is adapted to charge the intake passage when the engine is initially started.

Variation 8 may include a product according to any of variations 5-7 wherein flow is closed without including a shut off valve separate from the flow control device.

Variation 9 may include a product according to any of variations 6-8 wherein the vanes prevent reverse flow through the flow control device when the second compressor is driven.

Variation 10 may include a product according to any of variations 6-9 wherein the vanes are configured to be open to impart swirl to a gas stream in the intake passage.

The above description of select variations within the scope of the invention is merely illustrative in nature and, thus, variations or variants thereof are not to be regarded as a departure from the spirit and scope of the invention.

What is claimed is:

1. A method of controlling a compressor bypass in a charging system for an internal combustion engine including the steps of:
a. providing a first compressor;
b. connecting the first compressor in an intake passage of the internal combustion engine;
c. providing a second compressor;
d. connecting the second compressor in the intake passage of the internal combustion engine;
e. providing a bypass passage in the intake passage around the second compressor so that gas can flow through the bypass passage without being forced through the second compressor;
f. connecting a flow control device having a number of vanes in the bypass passage;
g. selectively positioning the vanes in the flow control device to a closed position to force flow through the second compressor.

2. A method of controlling a compressor bypass according to claim 1 including the step of opening the vanes to impart swirl in the intake passage and into the first compressor.

3. A method of controlling a compressor bypass according to claim 2 including the step of operating the first and second compressors concurrently.

4. A method of controlling a compressor bypass according to claim 2 including the step of operating the second compressor when the engine is initially started and the vanes are positioned in the closed position.

5. A product for use with an engine comprising: an intake passage providing combustion air to the engine; an exhaust passage channeling expelled combustion gases from the engine; a first compressor disposed in the intake passage; a turbine disposed in the exhaust passage and coupled to the first compressor and arranged to rotate as a result of a flow of exhaust gases through the exhaust passage to drive the first compressor; a flow control device disposed in the intake passage upstream from the first compressor; an alternate passage having a first end opening to the intake passage upstream from the flow control device and having a second end opening to the intake passage downstream from the flow control device; a second compressor disposed in the alternate passage; and a drive unit adapted to drive the second compressor; wherein the flow control device is configured to be closed to substantially prevent flow through the flow control device and force flow through the alternate passage.

6. A product according to claim 5 wherein the flow control device includes a number of vanes that are shaped to substantially close flow through the flow control device when positioned perpendicular to flow.

7. A product according to claim 6 wherein the vanes are configured to close flow and the second compressor is adapted to charge the intake passage when the engine is initially started.

8. A product according to claim 7 wherein flow is closed without including a shut off valve separate from the flow control device.

9. A product according to claim 8 wherein the vanes prevent reverse flow through the flow control device when the second compressor is driven.

10. A product according to claim 9 wherein the vanes are configured to be open to impart swirl to a gas stream in the intake passage.
